(19) United States
(12) Patent Application Publication
(10) Pub. No.: US 2011/0292952 A1
(43) Pub. Date: Dec. 1, 2011

(54) LASER DEVICE WITH HIGH AVERAGE POWER FIBER

(75) Inventors: Johan Boullet, Bordeaux (FR); Francois Salin, Gradignan (FR); Eric Cormier, Cestas (FR)

(73) Assignee: Centre National de la Recherche Scientifique (CNRS), Paris (FR)

(21) Appl. No.: 13/061,562

(22) PCT Filed: Sep. 2, 2009
(86) PCT No.: PCT/FR2009/001053

§ 371 Date: Aug. 23, 2011

(30) Foreign Application Priority Data
Sep. 2, 2008 (FR) 0855879

(51) Int. Cl. H01S 3/067; H01S 3/0941

(52) U.S. Cl. 372/6

(57) ABSTRACT

The disclosure relates to a laser device having a fibre emitting a single-mode transverse radiation controlled at a given wavelength, which includes: at least one laser diode capable of emitting a pump wave and a sheathed amplifying optic-fibre segment having two ends, the amplifying optic fibre including a core and a pumping sheath, the fibre being doped with a rare-earth dopant, wherein the core of the fibre has a diameter of between 12 μm and 200 μm, and in that the device includes: a coupling means for coupling the pump wave in the pumping sheath to at least one end of the fibre, and a resonator capable of re-injecting a laser beam at the given wavelength at the two ends of said segment, said resonator including an intra-cavity wavelength selective means capable of interaction with the injection means so as to perform a filtration on the given wavelength and re-inject into the fibre the pump wave which has not been absorbed after passing in the fibre.

### CROSS-REFERENCE TO RELATED APPLICATIONS

This application is a National Phase Entry of International Application No. PCT/FR2009/001053, filed on Sep. 2, 2009, which claims priority to French application Ser. No. 08/55879, filed on Sep. 2, 2008, both of which are incorporated by reference herein.

### TECHNICAL FIELD OF THE INVENTION

The invention relates to an optic fibre laser device delivering a single-mode transverse beam with high average power. The present invention relates to high power fibre lasers emitting in the spectral band between 970 nm and 985 nm.

### BACKGROUND

In the field of optic-fibre telecommunications networks, it is necessary to have efficient and highly brilliant laser sources for pumping amplifiers doped with Erbium ions having an infrared wavelength close to 976 nm. This high pump-power density makes it possible to consider a simultaneous increase in the number of the amplified spectral channels and/or the increase of the distance between two amplifiers over the long distance networks.

In these telecommunications networks, the necessary pump power should be the highest possible and the beam should remain at the diffraction limit (i.e. having simultaneously, a high power and a high brilliance). Having a high brilliance and a high power fundamental laser source of about 976 nm allows, via a frequency conversion stage, to also have a blue harmonic source with the same characteristics (power and brilliance). This blue harmonic wavelength, of approximately 488 nm, is favourably used in the fields of biology, surgery and medicine.

The laser sources at substantially 488 nm are generally argon gas lasers. These sources sometimes comprise two lines situated at wavelengths between 514.5 nm and 488 nm. The laser sources with two lines at substantially 514.5 nm and 488 nm are performed in a gaseous medium, as there is no solid-state laser emitting directly at these wavelengths.

In the fields of biology or medicine wherein they find an application, these laser sources of substantially 488 nm, should preferably have an excellent spatial quality so as to focus the beam on the smallest possible volume. Another application of these fibre laser sources emitting at substantially 976 nm is the possibility of high power pumping of lasers and amplifiers. The high pump intensities which can be reached makes it possible to achieve fibered or crystal amplifying medium short oscillators or amplifiers doped with Erbium or Ytterbium ions, in steady, triggered, or ultra-short pulses regime.

Nowadays, this spectral band at substantially 976 nm in the infrared range is obtained from semiconductor laser diodes. These laser diodes relate, preferably, to transverse single-mode laser diodes (low power) and/or high-power laser diodes (multimode).

The choice of using laser sources in the infrared wavelength range is justified by the advantages they offer, particularly: their compactness, their life span, their high electrical efficiency or their low manufacturing cost. Yet, the choice of these laser diodes can only be a compromise between beam quality and power, which is an undeniable drawback in situations where a high power density is required. Indeed, the transverse single-mode laser diodes deliver a power limited to a few hundred milliwatts, whereas the high-power laser diodes, emitting several watts, have a high multimode beam, i.e., of a weak spatial quality.

In order to mitigate these limitations, it has been known from prior art infrared laser sources described in publication “Singlemode emitter array laser bars for high-brightness applications”, extracted from document called “IEEE 19th International Semiconductor Laser Conference Digest, ThA6, pp. 45-6 (2004)”, by N. Lichtenstein, Y. Manz, P. Mauron, A. Fily and S. Arit. This publication describes a semiconductor amplifier generating a radiation of 976 nm at a power of 1.4 W from a 1×3 μm laser diode. Yet in this amplifier, the generated power is limited to a few watts as a result of the small emitting surface.

Thus, a solution for increasing power is the use of a funnel-shaped laser diode that makes it possible to obtain high powers, but with more important spectral width of around 4-5 nm. Such a solution is described in a publication called “Nearly-diffraction limited 980 nm tapered laser diode lasers with an output power of 6.7 W”, published in the document “Conference digest of 19th ISLC, IEEE, pp. 43-4 (2004)” and written by K. Paschke B. Sumpf, F. Dittmar, G. Erbert, J. Fricke, A. Knauer, S. Schwertfeger, H. Wenzel and G. Tränkle. However, the main drawback of sources like funnel-shaped laser diodes is the high dependency of their spectre on temperature, and therefore on structure heating and on pumping power.

In addition, such a solution is hard to implement, expensive, exhibits a high encumbrance and suffers from unreliability since it requires a sensitive alignment. Moreover, the maximum power that such a laser can deliver is limited to about 10 W. The production of TEM00 radiation at substantially 488 nm by beam doubling at 976 nm is therefore also limited to 1 W. On the other hand, the direct emission of the radiation at 488 nm by an Ar technique is limited to a few W.

Furthermore, it is known from the anterior art, lasers architectures wherein the amplifier medium is a material doped by Yb ions used for realizing laser sources at substantially 976 nm. These laser architectures comprise optical pumping devices emitting over the spectral band between 910 nm and 940 nm.

The solutions based on materials doped with rare-earth ions, for example Ytterbium ions, diode pumped, use either crystals or optic fibres wherein the dopant ions are incorporated. The fibre solution has the advantage of being with a fully fibered solution and therefore compact, ultrastable and reliable. In addition, from the solution brought by the solid amplifying media doped with rare-earth ions and emitting at substantially 976 nm allows to make an opto-optical conversion between the power brought by the pump and the power delivered by the laser which can go as far as 80%.

However, the emission of a solid amplifier medium (crystal or silica) doped with ytterbium ions at substantially 977 nm laser wavelength involves considerable constraints on the geometry of the amplifier (transverse section and length of amplifying medium), of the pumping beam and of the pumping level. In order to produce this emission at substantially 977 nm wavelength, the pumping intensity should exceed a limit value, said transparency intensity (˜30 kW/cm²) for the silica doped with ytterbium ions when it is pumped at substantially 915 nm and when it is desired to emit at substantially 977 nm) necessary for realizing the optical amplification. When the amplifying medium is a crystal doped with ytterbium ions, the necessary pump intensity is obtained by highly focusing the pump laser, the useful length of crystal being limited by the Rayleigh zone of the pump beam. The pump source should be chosen brilliant enough to ensure the transparency over the length of the crystal. The solution brought by the doped optic fibre prevents this constraint over the length of Rayleigh, as the pump beam is guided by the fibre, which makes it possible to obtain high pump intensities over long fibre lengths. To maximize the pump intensity in the doped zone (core of the fibre), it has been first suggested to directly inject the pump wave in the single-mode doped core. However, this pumping technique requires the use of semiconductor laser diodes (or any other laser source) in the band ranging between 910 nm and 940 nm limited by the diffraction and therefore not powerful (<1 W). Another solution consists in guiding a more powerful multimode pump through a concentric guiding sheath with a doped core, called pumping sheath. This latter should however have a limited section to insure at any point of the fibre the condition local pump intensity superior to the intensity of the transparency.

So far, the limited power of the pumping diodes over the band between 910 nm and 940 nm led to limit the diameter of the pumping sheathes at ˜25 μm, allowing also to develop optic fibres laser sources doped with rare-earth ions delivering an average power of 3.5 W at the maximum over an infrared wavelength range of substantially 977 nm, with strong constraints on the level of the used pumping and the used fibre geometry. These works, which have so far represented the record level of fibre laser emission at substantially 977 nm, are reported in the publication [K. H. Yllä Jarkko, R. Selvas, D. B. Soh, J. K. Sahu, C. A. Codemard, J. Nillson, S. A. Allam and A. B. Grudinin, “A 3.5 W 977 nm jacketed air clad fiber laser ytterbium doped fiber laser”, OSA Trends in Optics and Photonics. Advanced Solid State Lasers Vol. 34, (2000).]

Nowadays, the technical progress of the semiconductor lasers' technology led to making the highly powered (10 W-1 kW) fibre laser diodes over the band between 910 nm and 940 nm available in the market wherein the multimode beam is delivered on fibres the diameter of which is between 100 μm and 800 μm under a numerical aperture of about 0.22. Once more powerful diodes are used, it is possible to prevent the constraint linked to the level of pumping required to attain the transparency of the material. However, the use of fibres having pump sheath diameters compatible with the use of these highly powerful diodes leads to a new physical lock for the laser emission at substantially 977 nm. Indeed, to emit a single-mode laser beam, the core of the doped fibre should present a limited diameter core. The fibre used in the publication [K. H. Yllä Jarkko, R. Selvas, D. B. Soh, J. K. Sahu, C. A. Codemard, J. Nillson, S. A. Allam and A. B. Grudinin, “A 3.5 W 977 nm jacketed air clad fiber laser ytterbium doped fiber laser” OSA Trends in Optics and Photonics, Advanced Solid State Lasers Vol. 34, (2000)] has a core of 9 μm diameter.

Currently, the classical fibres technologies do not allow to go beyond core diameters of about 12 μm to remain limited by the diffraction. Thus, the overlap between the pump wave propagating in the pump sheath and the doped core is very small. Considering this small overlap between pump wave and doped core, the fibre lengths necessary for absorbing the injected pump wave are typically of several meters, even some ten meters.

Yet, when the fibre length is increased, the laser line having a wavelength in the band between 1010 nm and 1100 nm, for which these fibres are usually used, has a much higher gain than that of the line around which it is desired to obtain a laser radiation of substantially 977 nm. The study of the influence of this parasitic gain and of the limitations that result from it are stated in the publication [J. Nilsson, J. D. Minelly, R. Paschotta, A. C. Tropper, and A. C Hanna, “Ring doped cladding pumped single-mode three level fiber laser”, Opt. Lett. 23, 355 (1998)].

Thus, to obtain an infrared fibre laser source at about 977 nm, it is advisable to use an adequately short fibre to limit the parasitic gain in the 1010 nm-1100 nm spectral band. However, a fibre achieving this condition, in view of the limited section of its core, will have the inconvenience of not absorbing the pump wave of the laser diode. The laser designed with such a fibre will be thus of a low and limited power.

### SUMMARY

The invention aims at resolving the problems linked to the technical difficulties encountered in generating infrared fundamental wavelength range laser sources at substantially 977 nm wavelength at the output of a laser system wherein the amplifying medium is an optic fibre doped with rare-earth ions. This laser is compact, low cost, and highly powerful. The invention offers to improve the highly powerful fibre laser devices by the use of doped fibre wherein the core diameter is highly increased compared to the diameters of the standard single-mode fibres, and which is capable of providing the laser wave with a single-mode optical guidance so as to increase the laser beam power.

More specifically, the invention relates to a fibre laser device emitting a single-mode transverse radiation controlled at a given wavelength comprising:

at least one laser diode capable of emitting a pump wave, and

a sheathed amplifying optic fibre segment having two ends, said amplifying optic fibre comprising a core the diameter of which is between 12 μm and 200 μm and a pump sheath, the fibre being doped with a rare-earth dopant, said device comprising:

pump wave coupling means for coupling the pump wave in the pumping sheath to at least one end of the fibre, and

a resonator capable of re-injecting a laser beam at the given wavelength at the two ends of said segment,

said resonator comprising intra-cavity wavelength selective elements capable of cooperating with the injection means so as to filter on the given wavelength and to also re-inject into the fibre (6) the non absorbed pump wave after a passage in the fibre (6).

Favourably, the cooperation of the selective means with the injection means allows the infliction of losses in the spectral band of the parasitic radiation between 1010 nm and 1100 nm.

According to specific embodiments:

the coupling means comprise two lenses, said lenses being chosen among at least anyone of the following lenses: microlens, cylindrical lens, elliptical lens, hyperbolic lens, or aspheric condensers;

the coupling means relate to a coupler including N input multimode fibres which can be directly welded to fibre outputs of N pump diodes and an output fibre with or without a guidance core supporting the propagation of a mode roughly similar to that of the amplifying fibre, which can be directly welded to the wide core amplifying fibre.

the coupling means relate to a large mode optic fibre wherein the transverse section is progressively thinned so as to adopt a funnel shape structure,

the large mode fibre having one end with the same diameter as the fibre delivering the pump wave and the other end with the diameter of the amplifying fibre sheath so as said funnel is welded on one end to the fibre delivering the pump beam and on the other end is welded to the large mode fibre.

the selective elements relate to an element chosen among at least one of the following elements: a dichroic mirror, an absorbing or interferometric fibre, a amplifying fibre curvature, a dopant element added to the constitution of the amplifying fibre core, an external bulky grating, a prism, a Bragg grating photo-written in the core of the amplifying fibre or a Bragg grating outside the amplifying fibre;

the fibre is a large mode area fibre, or LMA fibre;

the diameter of the pump sheath ranges between 0 and 800 μm;

the core and the sheath are concentric;

the core has a diameter larger than 12 μm;

the fibre is doped with an element chosen among at least one of the following elements: ytterbium ions, germanium, phosphorous, boron or fluorine;

the fibre is capable of emitting a beam at the diffraction limit at the core output;

the fibre is inherently a polarization-holding fibre or secured in a fixed position;

the large mode fibre is silica-air micro-structured fibre;

the fibre is rigid because it is held in a pure silica rod the external diameter of which is larger than 1 mm (“rod-type fiber” fibre technology)

the fibre is flexible.

the fibre sheath is a wave guide, capable of performing the pump wave guidance, formed by an air hole ring, called air sheath, having a numerical aperture larger than 0.5;

the guidance of the wave at substantially 977 nm wavelength is performed by an array of air holes parallel to the optical axis surrounding the doped core;

the fibre belongs to the air-silica micro-structured fibre family.

the given wavelength is situated in the infrared;

the amplifying fibre has a reduced length so as to keep the laser sheath of the parasitic radiation in 1010 nm-1100 nm band inferior to 60 dB;

the laser diode delivers powers between 10 and 1000 W, and

the pump wave is coupled to a multimode fibre the diameter of which ranges between 50 μm and 800 μm.

### BRIEF DESCRIPTION OF THE FIGURES

Other characteristics and advantages of the invention will become more apparent upon reading the following description, with reference to the accompanying drawings, which illustrate:

FIG. 1, illustrates the device representation according to an embodiment of the invention;

FIG. 2, represents the section of an optic fibre according to an embodiment of the invention;

FIG. 3A, illustrates the ytterbium ions absorption and emission spectra when they are inserted into a silica matrix, which is the case in an optic fibre;

FIG. 3B, illustrates the ytterbium ions energy levels;

FIG. 4, illustrates the laser power of the three-energy level high power fibre according to the pump power; and

FIGS. 5A and 5B, illustrate the laser output spectrum, according to an embodiment of the invention.

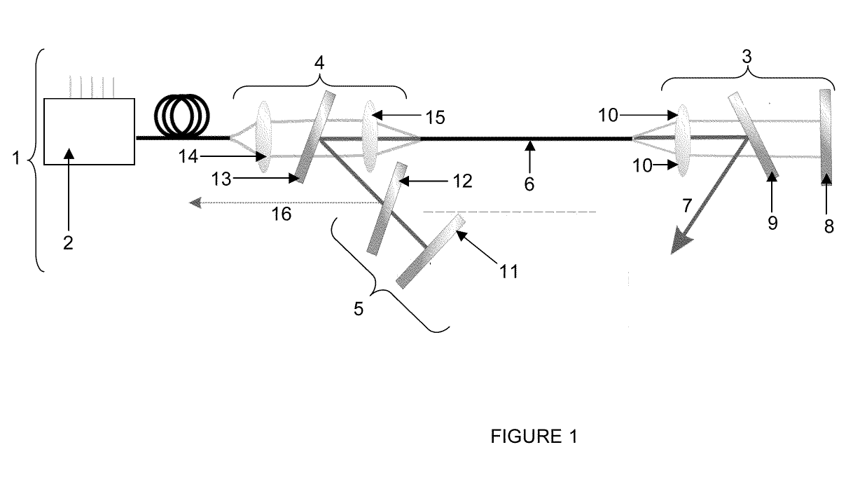

For the sake of clarity, identical or similar elements are marked by identical reference signs on all the figures.

### DETAILED DESCRIPTION OF AN EMBODIMENT

In an exemplary embodiment of the device, according to the invention, illustrated in Figure A, the device 1 comprises:

a laser diode 2;

an amplifying optic fibre 6;

coupling means 4;

a resonator including wavelength selective elements 5, 13.

The used laser diode 2 is a transverse multimode pumping source of about 915 nm, the power of which is of 230 W, wherein the emitted radiation is delivered by an optic fibre the diameter of which is 400 μm and exhibiting a numerical aperture NA=0.22.

The lens 10 having a numerical aperture of 0.5 and a focal aperture of 8 nm and the dichroic mirror 9 is completely reflective at the pumping wavelength of about 915 nm. The coupling means of the pump wave in the doped fibre sheath comprise two focal lenses, respectively, 18 mm and 8 mm 14 and 15 and a transparent dichroic mirror at the pump wavelength and reflecting at the laser wavelength 13. The selective optics relate to two dichroic mirrors 11 and 12.

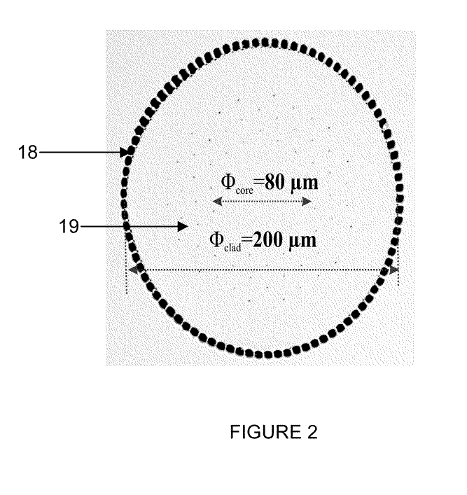

The optic fibre 6 is a photonics crystal fibre also called in English “rod-type photonic crystal fibres”. This fibre is of a reduced length not exceeding 1.23 m. A section of this fibre is illustrated in FIG. 2. Unlike the classical fibres, the photonic fibres do not consist entirely of transparent solid material such as the doped silica; in section, a photonic fibre has an air hole array.

These holes are parallel to the fibre axis, and extend longitudinally along the fibre. Practically, these holes may be obtained by manufacturing the preform via assembly of capillary tubes or silica cylinders, with respect to the hole pattern to be obtained in the fibre. The drawing of such a preform provides a fibre with holes corresponding to the capillary tubes.

The presence of these holes in the fibre material creates variations in the average index of the material. These index variations can, as in a classical optic fibre, be used for internal total reflection guidance of light signals at suitable wavelengths. This fibre 6 is a constitutive element of device 1 allowing to implement a high-power three-level energy fibre laser.

It is noted that this type of fibre laser is more compact, more stable and does not require any cooling mode when compared to semiconductor technologies. It has also a better beam quality, the quality of the beam being imposed by the guidance properties of the fibre, thus, it has a better resolution for labelling applications.

This optic fibre is doped with a rare-earth ion which, in this embodiment, is mainly ytterbium. It is therefore an ytterbium (Yb) doped optic fibre ultralarge core rod-type (otherwise called in English “rod-type fiber”). Ytterbium belongs to the category of rare-earth ions or metal ions which are commonly used for achieving laser sources. Among all the usable ions, only these ytterbium ions, which are part of the rare-earth ions, exhibit a transition around 976 nm.

It is noted that for the used fibre, area ratio of the core/sheath, is substantially of 6.5. In another embodiment, this ratio ranges between 5 and 100.

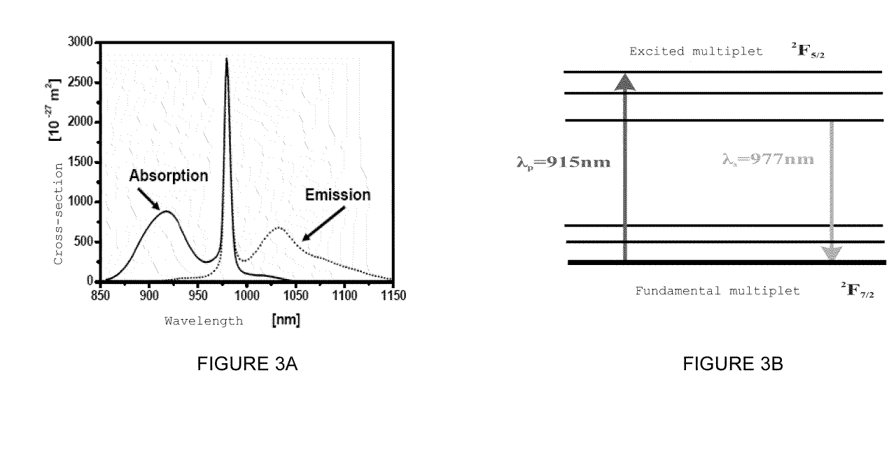

FIG. 3A illustrates the absorption and emission spectra of the Yb³⁺ ions in silica, the materials doped with the Yb³⁺ ions have a very important emission cross-section to 976 nm, associated to an absorption band to 915 nm. More particularly, FIG. 3A shows that the Ytterbium absorption cross-section in glasses is largely more important than the emission cross-section. According to the crystalline or amorphous matrix used, the emission cross-sections to 976 nm and absorption to 915 are more or less high. With an absorption band of tens of nanometres of width at half-height to 915 nm, the diode pumping is feasible. Nevertheless, this high emission about 976 nm is accompanied by a similarly intense absorption.

In FIG. 3B it is noticed that the pumping is performed between the multiplet² F7/2 lowest sub-level and the multiplet³ F5/2 highest sub-level. The emission takes place between multiplet³ F5/2 lowest sub-level and the multiplet² F7/2 lowest sub-level. Thus, a real three-level transition is obtained, which imposes important constraints on these materials' pumping to obtain the emission about 976 nm.

The material doped with ytterbium ions absorbs any radiation about 976 nm in the absence of pumping. To obtain an emission to 976 nm, the material's pumping should be intense enough for creating the population inversion of transparency at 976 nm wavelength in the doped medium. In other words, it is therefore required that the pumping intensity about 915 be sufficient to reach the doped medium transparency to 976 nm. This intensity, corresponding to the cancelling of the absorption at the laser wavelength 976 nm in the material, is called transparency intensity.

The use of this silica fibre doped with Yb³⁺ ions makes it possible to confine the pump in the doped medium, and easily reach the transparency intensity over the length of this doped medium. This fibre ensures thus a high interaction of the pump beam with the dopant ion, over a substantial length thanks to the containment of the light in the fibre pump sheath. This fibre doped with ytterbium used for this transition is a transverse single-mode fibre having record level dimensions (diameter of 80 μm) for a single-mode fibre. Such extreme dimensions of the doped core are made possible by the array of very small air holes (the diameter of which is smaller than 100 nm, illustrated in FIG. 2, element 19) reducing the average index of the sheath surrounding the doped core and allowing to obtain a numerical aperture of the order of 0.01.

The signal at substantially 977 nm propagates in the doped core of 80 μm diameter and the pump at substantially 915 nm propagates inside the optic sheath of a 200 μm diameter with a large numerical aperture larger than 0.7. This sheath is defined by a microstructure filled of air (illustrated in FIG. 2, element 18). This microstructure comprises much bigger holes than those defining the core (>2 μm) according to a pattern that preserves the symmetry of the fibre abound its longitudinal axis. It is specified that the dimensions of the holes defining respectively the core and the sheath of the fibre can be adjusted according to the desired guidance characteristics: core diameter, numerical aperture of the sheath or the core.

In the configuration of the optic sheath pumping, this fibre has a pump absorption of the value of 10 dB/m at 915 nm. It allows, thanks to a very efficient doped pump-core overlap to absorb 230 W of pump over very short lengths of 123 cm. Over such a length, the pumping intensity remains homogeneously inferior, over the whole length of the fibre, to the transparency intensity and the parasitic sheath in the spectral band between 1010 nm and 1100 nm low enough to be compensated by all (5) the wavelength selective elements.

In this device, the laser diode 2 emits a wavelength radiation ranging between 910 and 940 nm. In a specific embodiment, the used pump laser diode delivers powers from 10 W to 1000 W, the pump beam can be delivered directly in free space, or be coupled to a multimode fibre, having diameters between 50 and 800 μm. Light issued from the pump diode is coupled to a transport fibre then injected in the amplifying fibre 6 thanks to optical means 4. These coupling means 4 comprise in this specific configuration two lenses 14 and 15.

The optical means 4 are designed so as to couple the light issued from the transport fibre in the laser fibre. In particular, these optic fibres have an enlargement that allows the pump transport fibre core image on the laser output to have a dimension substantially equal or inferior to the diameter of the pump sheath 6 of the laser fibre. Likewise, these optical means 4 have a numerical aperture equal to or larger than the product ON₁/G wherein G is the enlargement of the optical system 4 and ON₁ is the numerical aperture of the transport fibre.

For example, if the 915 nm multimode diode 2 is coupled to a fibre of 400μ diameter and of a numerical aperture of 0.22, and the laser fibre of FIG. 2 wherein the pump sheath 18 has a diameter of 200 μm and a numerical aperture of 0.7, the optical means should have an enlargement G≦200/400=0.5 and an image numerical aperture of at least 0.5. In the example presented here, the optic means are composed of a couple of two aspheric lenses: a first lens 14 of focal 18 mm and a second lens 15 of focal 8 mm. Lens 15 of 8 mm has a numerical aperture of 0.5. In a specific embodiment, these two lenses can be microlenses, cylindrical, elliptic, or hyperbolic, or aspheric condensers.

In another embodiment, the coupling means can be:

A coupler comprising N input multimode fibres capable of being directly welded to the fibre outputs of N pumping diodes and an output fibre capable of being directly welded to the wide core amplifying fibre.

A large mode optic fibre wherein the transverse section is progressively thinned so as to adopt a funnel shape structure. This fibre has one end with the same diameter as the fibre delivering the pump wave and the other end has the diameter of the amplifying fibre sheath.

When the coupling means relate to a fibre section, the two ends of this “funnel” fibre are then welded respectively at the outlet of the diode 2 transport fibre and at the inlet of the wide doped core amplifying fibre 6. In FIG. 2, the fibre has a geometry that allows a single-mode propagation in the core 19 and a multimode propagation in the pumping sheath. The ratio of the diameters of the core 19 to the pump sheath is smaller than 10. In this specific embodiment, the transverse single-mode fibre has important dimensions with a doped core 19 diameter of 80 μm. Such dimensions of the doped core are made possible by the very small air hole array (<100 nm of diameter) reducing the sheath average index and allowing to obtain a core numerical aperture of the order of 0.01.

The signal at substantially 977 nm propagates in the doped core of 80 μm diameter 19 and the pump of subsequently 915 nm propagates at the interior of the optic sheath of a 200 μm diameter with a large numerical aperture superior to 0.7. This sheath is defined by a microstructure filled with air 18. This microstructure 18 comprises much larger holes than those defining the core (>2 μm) according to a pattern that preserves the symmetry of the fibre about its longitudinal axis.

For lower powers, it is possible to use smaller cores. The ratio of the fibre 6 doped core 19 transverse surfaces to the pump sheath 18 should remain in the interval ranging between 5 and 100 and preferably closer to 5. The fibre sheath 6 can have a pump guidance sheath diameter of 18 between 50 and 400 μm.

The amplifying fibre has a single-mode propagation of the beam in the doped core at wavelength of substantially 977 nm. The fibre is intrinsically a polarization-holding fibre or simply held in a fix position. The fibre core may comprise in addition to the rare-earth dopant ions one or more of the following chemical species: Germanium, Phosphorus, Boron, Fluorine.

The fibre doped core 18 has a diameter larger than 12 μm. It is therefore a large mode area fibre or LMA fibre (Large Mode Area). The large mode area can be an air-silica micro-structured fibre, rigid or flexible. The fibre 6 length is chosen so as the pumping intensity at the fibre output is higher than the transparency intensity at the output of the fibre and that the undesirable gain in the band between 1010 nm and 1100 nm is maintained smaller than 60 dB.

In this embodiment, for 230 W of injected pump, 63 W of residual pump power is measured after a propagation length of 123 cm, for a calculated transparency power of 11 W. This power corresponds to transparency intensities of 30 KW/cm2 and a transverse section of the pumping sheath 18 of 31500 μm. In this embodiment, the gain of 1030 nm is substantially of 50 dB. The residual pump wave at the output of the pumping sheath as well as the laser wave exiting from the amplifying fibre 6 are thus collimated by an optical means 10.

The laser wave is reflected by the mirror 9, completely reflecting at the laser wavelength of substantially 977 nm whereas the pump of subsequently 915 nm is not reflected. This residual pump is thus incident upon a mirror 8 highly reflecting the 915 nm pump wavelength in this embodiment. The position of the mirror is calculated so as the pump beam reflected by the mirror be exactly re-injected in the pump sheath of the laser fibre. For a plane mirror, this position corresponds to that of the image of the output surface of the laser fibre through the optic means 10.

The pump wave performs then a second trip in the laser fibre, increasing thus the pump absorption, and increasing the population inversion, as well as the efficiency of the laser. In another embodiment, this recycling means of the pump can be a Bragg grating photo-written in the core of the fibre, or a bulk Bragg grating in free space, or a prism, or a network.

A dichroic mirror 13 is placed between the two optical means 14 and 15. This dichroic mirror is completely reflecting about 977 nm and completely transparent at the pump wavelength. A second mirror 11 completely reflecting about 977 nm is placed on the laser beam trajectory to form a resonator with the fibre surface opposite to the pump.

In another embodiment, the resonator corresponds to mirrors with high-reflectivity (HR) or with a reflectivity that ends at the wavelength of substantially 977 nm. The reinjection devices at the fibre ends can be Bragg grating photo-written directly into the doped core of the fibre reflecting at the wavelength of substantially 977 nm, or fibre sections not doped with Bragg grating reflecting over the wavelength of substantially 977 nm written on the core, these fibre sections being welded to the amplifying fibre. The reinjection devices at the ends of the fibre can be bulky Bragg gratings. One or several elements constituting the resonator may be wavelength selective, i.e., reflecting at wavelength of substantially 977 nm and of very low reflectivity in the band (1010 nm-1100 nm).

All the optical elements 5 comprise the completely transparent mirror 12 at the laser wavelength of 977 nm and having a reflectivity >99% in the band between 1010 nm and 1100 nm, and the cavity base mirror 11 that has a transmission >99% in the band between 1010 nm and 1100 nm. In total, this whole causes sufficient losses in the band between 1010 nm and 1100 nm to ensure that the laser oscillates spontaneously around 977 nm.

In another configuration, the means for selecting over a wavelength relates to:

one or several dichroic mirrors capable of reflecting a signal of a defined wavelength;

on specific curvature of the amplifying fibre;

a dopant element added in the constitution of the absorbent fibre core in the band between 1010 nm and 1100 nm, or

a Bragg grating photo-written in the fibre core or a bulk Bragg grating outside the fibre;

a prism or an array.

This device 1 allows thus to generate a laser of about 976 nm power allowing to easily reach powers of the order of hundreds of watts, against 10 W in the state of the art, with an excellent beam quality. The laser 7 delivers a transverse single-mode beam 7 about 976 nm which is very powerful.

The device, by combination of:

a bar-like ultra large core Yb doped fibre

spectrally selective optics allowing the elimination of the parasitic laser effects on the non desired wavelengths, and

an optic allowing to recycle the non absorbed pump, allows to produce these power levels of more than 100 W, even 1 kW at 977 nm following the power of the pump diode at substantially 915 nm.

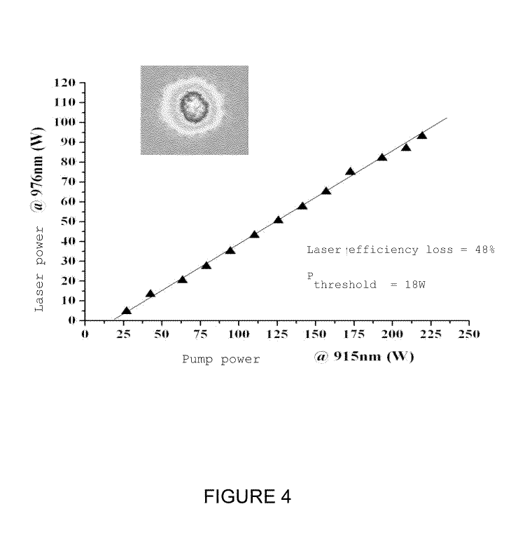

In FIG. 4, is illustrated the high-power three-level energy fibre laser of substantially 977 nm depending on the pump power of subsequently 915 nm. The laser threshold is reached at the diode pump power value between 18 W and 915 nm. At the maximum of the available pump power, at 230 W, the laser produces a power up to 94 W at 977 nm. The efficient laser slop between the pump power and the laser power is 48%. The quality of the laser beam remains excellent at such power values, and the performances of the device are limited by the available pump power of the diode.

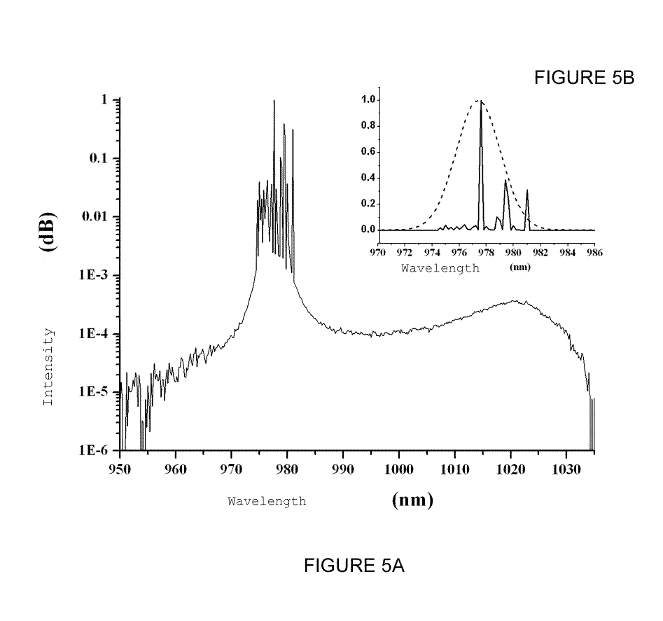

FIG. 5A represents the laser output spectrum measured at full output power from an optical spectrum analyzer with a resolution of 0.07 nm. As shown in this figure, the laser oscillates spontaneously on a spectral interval of 6 nm cantered at 977 nm.

Given the efficient spectral filtering of the action of the combination of the second and third mirrors 12, 11, the parasitic emission at 1030 is 35 dB below the laser maximal signal at 977 nm. More than 98% of the spectral power density is contained in the spectral interval between 975 nm and 980 nm. By comparison, FIG. 5B illustrates the laser output spectrum as well as the amplifying spontaneous spectrum of the emission obtained by removing the mirror feedback 11.

Furthermore, the doped fibre has a highly large core diameter compared to the standard single-mode fibre diameters (i.e. having cores with diameter <12 μm). The core diameter is selected between 12 μm and 200 μm. In order to reach the highest powers, the invention implements the use of large air mode (LMA) special optic fibres with index jump or micro-structured, that may have record level core diameters >up until 80 μm currently while insuring a single-mode optical guidance of the laser wave about 977 nm. The device according to the invention allows also to obtain a high power laser at 488 nm as it has an excellent spatial quality allowing to focus the beam on the most reduced volume possible and a sufficient power to obtain substantial efficiencies in the non-linear stage.

This device is a solid state laser medium emitting directly at wavelengths of substantially 488 nm, which has the advantage of being more compact, more reliable and less expensive than the devices using a solid state medium emitting between 800 and 1100 nm to which is connected a non linear optical stage for mixing or doubling the frequency. These devices implement a process consisting in producing a radiation at 976 nm or at 1029 nm and doubling it in frequency. Such a frequency doubling non-linear stage imposes considerable constraints on the characteristics of the fundamental beam at 976 or 1029 nm.

The invention is in no way limited to the described and illustrated embodiments. In addition, it is not limited to the exemplary embodiments and to the described variants. Indeed, in a variant the photonic optic fibre can be doped with rare-earth ions or metal ions apart from the ytterbium ions.

1. A fibre laser device emitting a transverse single-mode radiation controlled at a given wavelength comprising:
at least one laser diode operably emitting a pump wave;
a sheathed amplifying optic fibre section having two ends, the amplifying optic fibre comprising a core and a pumping sheath, the fibre being doped with a rare-earth dopant;
wherein the amplifying optic fibre core has a diameter ranging between 12 μm and 200 μm;
a pump wave coupling operably coupling the pump wave in the pumping sheath to at least one end of the fibre; and
a resonator operably re-injecting a laser beam at the given wavelength to both ends of the section;
the resonator comprising intra-cavity wavelength selective elements operably cooperating with the coupling so as to filter on the given wavelength and to also re-inject into the fibre the non-absorbed pump wave after a passage in the fibre.

2. The fibre laser device according to claim 1, wherein the coupling comprises two lenses, the lenses being selected among at least any one of the following lenses: microlens, cylindrical lens, elliptic lens, hyperbolic lens, and aspheric condensers.

3. The fibre laser device according to claim 1, wherein the coupling comprises N multimode input fibres operably welded directly to the fibre outputs of N pumping diodes and an output fibre operably directly welded to the amplifying fibre.

4. The fibre laser device according to claim 1, wherein the coupling comprises a large mode optic fibre wherein the transverse section is progressively thinned so as to adopt a funnel-shape structure.

5. The fibre laser device according to claim 4, wherein the large mode fibre has one end with the same diameter as the fibre delivering the pump wave and the other end having the diameter of the amplifying fibre sheath such that the funnel is welded to one end of the fibre delivering a pump beam and at the other end to the large mode fibre.

6. The fibre laser device according to claim 1, wherein the selective elements relate to an element chosen from at least one of the following elements: a dichroic mirror, an absorbent or interferometric filter, an amplifying fibre curvature, a dopant element added in the constitution of the amplifying fibre core, an external bulky grating, a prism, a Bragg grating photo-written in the amplifying fibre core, and a Bragg grating external to the amplifying fibre.

7. The fibre laser device according to claim 1, wherein the fibre is one of: a large mode area fibre and an LMA fibre.

8. The fibre laser device according to claim 1, wherein the pumping sheath diameter ranges between 50 μm and 400 μm.

9. The fibre laser device according to claim 1, wherein the core and the sheath are concentric.

10. The fibre laser device according to claim 1, wherein the core has a diameter larger than 12 μm.

11. The fibre laser device according to claim 1, wherein the fibre is doped with an element chosen among at least anyone of the following elements: ytterbium ions, neodymium ions, germanium, phosphorus, boron and fluorine.

12. The fibre laser device according to claim 1, wherein the fibre is capable of emitting a diffraction limit beam at the core output.

13. The fibre laser device according to claim 1, wherein the fibre is intrinsically one of: a polarization-holding fibre and held in a fixed position.

14. The fibre laser device according to claim 13, wherein the large mode fibre is an air-silica micro-structured fibre.

15. The fibre laser device according to claim 1, wherein the fibre is rigid and is held in a pure silica rod of which external diameter is larger than 1 mm.

16. The fibre laser device according to claim 1, wherein the fibre is flexible.

17. The fibre laser device according to claim 5, wherein the fibre sheath is a wave guide, capable of guiding the pump wave, made of an air hole ring comprising an air hole ring, called air sheath, having a numerical aperture larger than 0.5.

18. The fibre laser device according to claim 1, wherein the wave guidance at the wavelength of substantially 977 nm is performed by an air hole array parallel to the optical axis surrounding the doped core.

19. The fibre laser device according to claim 1, wherein the fibre belongs to the family of air-silica micro-structured fibres.

20. The fibre laser device according to claim 1, wherein the given wavelength is located in the infrared range.

21. The fibre laser device according to claim 1, wherein the fibre has a reduced length so as the laser sheath of the parasitic radiation in the spectral band between 1010 nm and 1100 nm remains smaller than 60 dB.

22. The fibre laser device according to claim 1, wherein the laser diode emits a pump wave in the spectral band between 910 nm and 940 nm.

23. The fibre laser device according to claim 1, wherein the laser diode delivers powers between 10 and 1000 W.

24. The fibre laser device according to claim 1, wherein the pump wave is coupled to a multimode fibre of a diameter ranging between 50 μm and 800 μm.
